(19) United States
(12) Patent Application Publication
(10) Pub. No.: US 2021/0142341 A1
(43) Pub. Date: May 13, 2021

(54) SYSTEM AND METHOD TO UNIQUELY IDENTIFY A USER ACROSS INTERNET AND NON-INTERNET CHANNELS

(71) Applicant: Terragon Holdings Mauritius, Ebene (MU)

(72) Inventors: Elochukwu UMEH, Lagos (NG); Ayodeji BALOGUN, Lagos (NG); Amit KHEMCHANDANI, Bengaluru (IN); Mohit RAWAT, Bengaluru (IN)

(73) Assignee: Terragon Holdings Mauritius, Ebene (MU)

(21) Appl. No.: 16/680,447

(22) Filed: Nov. 11, 2019

(51) Int. Cl. G06Q 30/02; G06F 16/958; G06F 16/955

(52) U.S. Cl. CPC G06Q 30/0201; G06F 16/955; G06F 16/958

(57) ABSTRACT

The present disclosure provides a user identifier system for uniquely identifying a user across internet and non-internet channels. The user identifier system receives a plurality of hypertext transfer protocol requests associated with one or more publishers. In addition, the user identifier system enables modification of a plurality of hypertext transfer protocol headers. Further, the user identifier system extracts a user data. Furthermore, the user identifier system maps the user data to a unique cookie identity in a cookie storing module. Moreover, the user identifier system transfers the unique cookie identity to one or more communication devices. The user identifier system retrieves the unique cookie identity when the user accesses the corresponding one or more publishers. The user identifier system engages the plurality of users to the one or more publishers across internet and non-internet channels.

### TECHNICAL FIELD

The present invention relates to the field of marketing and, in particular, relates to uniquely identify a user for online and offline marketing.

### INTRODUCTION

Internet and non-internet marketing is the fastest growing advertising medium in the last few years. Due to the advent of the internet, a vast number of users are engaged on the internet through their communication devices. Internet has become the greatest source for running the advertising business. Internet provides an extensive range of information about the users who are regularly indulged in browsing the internet. Advertisers and publishers have made use of this information of the users for generating and sharing revenue between each other. Publishers or website owners utilize this information for offering opportunities for online advertising or online marketing to advertisers through their web pages. Moreover, this information is accessed using the technologies available today which provide the online publishers with valuable data for advertising purposes. However, the present systems and methods for accessing the information of the users for the advertisements are inefficient. In addition, the present systems and methods do not take into account identification of the users with the advertisers on non-internet channels once the users are identified on internet channel. Further, the present systems and methods do not take into account identification of the users with the advertisers on internet channel once the users are identified on the non-internet channels.

In the light of the above stated discussion, there is a need for system that overcomes the above stated disadvantages.

### SUMMARY

In a first example, a computer-implemented method is provided. The computer-implemented method is configured for uniquely identifying a user across internet and non-internet channels. The computer-implemented method corresponds to a user identifier system. The computer-implemented method performs a first step of receiving a plurality of hypertext transfer protocol requests associated with one or more publishers through one or more browsers. In addition, the computer-implemented method performs a second step of enabling modification of a plurality of hypertext transfer protocol headers with hypertext transfer protocol enrichment associated with the one or more publishers. Further, the computer-implemented method performs a third step of extracting a user data associated with a plurality of users based on modified hypertext transfer protocol header through a user network information fetcher. Furthermore, the computer-implemented method performs a fourth step of mapping the user data associated with each of the plurality of users to a unique cookie identity in a cookie storing module based on cookie syncing. Moreover, the computer-implemented method performs a fifth step of transferring the unique cookie identity associated with the corresponding plurality of users to corresponding one or more communication devices. Also, the computer-implemented method performs a sixth step of retrieving the unique cookie identity associated with the corresponding one or more communication devices when the plurality of users accesses the corresponding one or more publishers. Also, the computer-implemented method performs a seventh step of engaging the plurality of users associated with the one or more communication devices to the one or more publishers across internet and non-internet channels. Also, the computer-implemented method performs an eighth step of identifying each of the plurality of users engaging across the internet and non-internet channels due to the mapped unique cookie identity of the user of the plurality of users. The one or more browsers are associated with the one or more communication devices. The one or more communication devices are associated with the plurality of users. The plurality of hypertext transfer protocol requests is received in real-time. The plurality of hypertext transfer protocol headers is modified in real-time. The user data is associated with one or more user network information. The user data is extracted in real-time. The cookie storing module is associated with the user identifier system. The unique user identity is mapped in real-time. The unique cookie identity is transferred in real-time. The unique cookie identity is retrieved in real-time.

In an embodiment of the present disclosure, the plurality of hypertext transfer protocol requests is initiated through the one or more browsers from the plurality of users. In addition, the plurality of users receives the response from the one or more publishers after processing the plurality of hypertext transfer protocol requests to access the one or more publishers webpage.

In an embodiment of the present disclosure, the one or more browsers is an application for accessing the information on the one or more publishers. In addition, the one or more browsers is pre-installed in the one or more communication devices. Further, the one or more browsers enable the plurality of users to access the internet through a communication network.

In an embodiment of the present disclosure, the one or more publishers include one or more website owners for providing content to a user of the plurality of users. In addition, the content includes one or more video contents, one or more audio contents, one or more text contents and one or more audio-video content.

In an embodiment of the present disclosure, the one or more communication devices include a personal e-mail device, a personal data assistant, a cellular telephone, a smartphone, a laptop computer, and the tablet computer. In addition, the plurality of users accesses the one or more publishers through the one or more communication devices using the communication network.

In an embodiment of the present disclosure, the plurality of hypertext transfer protocol headers of the plurality of hypertext transfer protocol requests for the one or more publishers is modified. In addition, the modification is done using the hypertext transfer protocol enrichment. Further, the plurality of hypertext transfer protocol headers is modified to enable extraction of the unique user identity.

In an embodiment of the present disclosure, the user data includes the one or more user network information. The one or more user network information include mobile station international subscriber directory number, international mobile subscriber identity and international mobile equipment identity. Further, the user data is mapped to the unique cookie identity in a cookie storing module based on the cookie syncing.

In an embodiment of the present disclosure, the cookie syncing maps the user of the plurality of users through sending the unique cookie identity to the cookie storing module. In addition, the cookie storing module stores the unique cookie identity of each of the plurality of users.

In an embodiment of the present disclosure, the unique cookie identity of the user of the plurality of users is transferred to the corresponding one or more communication devices. In addition, the transferred unique cookie identity of the user of the plurality of users is retrieved after the user accesses the corresponding one or more publishers.

In an embodiment of the present disclosure, each of the plurality of users accesses the one or more publisher through the one or more communication devices across internet and non-internet channels.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for uniquely identifying a user across internet and non-internet channels. The computer-implemented method corresponds to a user identifier system. The computer-implemented method performs a first step of receiving a plurality of hypertext transfer protocol requests associated with one or more publishers through one or more browsers. In addition, the computer-implemented method performs a second step of enabling modification of a plurality of hypertext transfer protocol headers with hypertext transfer protocol enrichment associated with the one or more publishers. Further, the computer-implemented method performs a third step of extracting a user data associated with a plurality of users based on modified hypertext transfer protocol header through a user network information fetcher. Furthermore, the computer-implemented method performs a fourth step of mapping the user data associated with each of the plurality of users to a unique cookie identity in a cookie storing module based on cookie syncing. Moreover, the computer-implemented method performs a fifth step of transferring the unique cookie identity associated with the corresponding plurality of users to corresponding one or more communication devices. Also, the computer-implemented method performs a sixth step of retrieving the unique cookie identity associated with the corresponding one or more communication devices when the plurality of users accesses the corresponding one or more publishers. Also, the computer-implemented method performs a seventh step of engaging the plurality of users associated with the one or more communication devices to the one or more publishers across internet and non-internet channels. Also, the computer-implemented method performs a eighth step of identifying each of the plurality of users engaging across the internet and non-internet channels due to the mapped unique cookie identity of the user of the plurality of users. The one or more browsers are associated with the one or more communication devices. The one or more communication devices are associated with the plurality of users. The plurality of hypertext transfer protocol requests is received in real-time. The plurality of hypertext transfer protocol headers is modified in real-time. The user data is associated with one or more user network information. The user data is extracted in real-time. The cookie storing module is associated with the user identifier system. The unique user identity is mapped in real-time. The unique cookie identity is transferred in real-time. The unique cookie identity is retrieved in real-time.

In a third example, a non-transitory computer-readable storage medium is provided. The non-transitory computer-readable storage medium encodes computer executable instructions that, when executed by at least one processor, performs a method for uniquely identifying a user across internet and non-internet channels. The computer-implemented method corresponds to a user identifier system. The computer-implemented method performs a first step of receiving a plurality of hypertext transfer protocol requests associated with one or more publishers through one or more browsers. In addition, the computer-implemented method performs a second step of enabling modification of a plurality of hypertext transfer protocol headers with hypertext transfer protocol enrichment associated with the one or more publishers. Further, the computer-implemented method performs a third step of extracting a user data associated with a plurality of users based on modified hypertext transfer protocol header through a user network information fetcher. Furthermore, the computer-implemented method performs a fourth step of mapping the user data associated with each of the plurality of users to a unique cookie identity in a cookie storing module based on cookie syncing. Moreover, the computer-implemented method performs a fifth step of transferring the unique cookie identity associated with the corresponding plurality of users to corresponding one or more communication devices. Also, the computer-implemented method performs a sixth step of retrieving the unique cookie identity associated with the corresponding one or more communication devices when the plurality of users accesses the corresponding one or more publishers. Also, the computer-implemented method performs a seventh step of engaging the plurality of users associated with the one or more communication devices to the one or more publishers across internet and non-internet channels. Also, the computer-implemented method performs a eighth step of identifying each of the plurality of users engaging across the internet and non-internet channels due to the mapped unique cookie identity of the user of the plurality of users. The one or more browsers are associated with the one or more communication devices. The one or more communication devices are associated with the plurality of users. The plurality of hypertext transfer protocol requests is received in real-time. The plurality of hypertext transfer protocol headers is modified in real-time. The user data is associated with one or more user network information. The user data is extracted in real-time. The cookie storing module is associated with the user identifier system. The unique user identity is mapped in real-time. The unique cookie identity is transferred in real-time. The unique cookie identity is retrieved in real-time.

### BRIEF DESCRIPTION OF THE FIGURES

Having thus described the invention in general terms, reference will now be made to the accompanying drawings, which are not necessarily drawn to scale, and wherein:

FIG. 1 illustrates a block diagram of a system for uniquely identifying a user across internet and non-internet channels, in accordance with various embodiments of the present disclosure;

FIGS. 2A and 2B illustrate a flow chart of a method for uniquely identifying a mobile user across internet and non-internet channels, in accordance with various embodiments of the present disclosure; and

FIG. 3 illustrates a block diagram of a communication device, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

FIG. 1 illustrates a block diagram of a system 100 for uniquely identifying a user across internet and non-internet channels, in accordance with another embodiment of the present disclosure. The system 100 includes a plurality of users 102, one or more communication devices 104, one or more browsers 104a, communication network 106, and a server 110. In addition, the system 100 includes one or more publishers 112, one or more advertisers 114 and a user identifier system 108. Further, the user identifier system 108 enables uniquely identification of the user across internet and non-internet channels associated with one or more publishers 112. In an embodiment of the present disclosure, the uniquely identification of the user across internet and non-internet channels is performed for serving one or more advertisements to the plurality of users 102 in real-time.

Furthermore, the system 100 enables the one or more publishers 112 to increase efficiency of the uniquely identifying the user for serving the one or more advertisements associated with an advertiser of the one or more advertisers 114. In addition, the user may be any person or individual currently accessing a communication device of the one or more communication devices 104. In an embodiment of the present disclosure, the communication device of the one or more communication devices 104 is a portable communication device. The one or more communication devices 104 include but may not be limited to a smart phone, a desktop computer, a laptop, a tablet, a personal digital assistant, a wearable device and any other portable communication device known in the art. In addition, the one or more communication devices 104 is associated with a specific type of operating system. The specific type of operating system associated with the one or more communication devices 104 includes but may not be limited to an Android operating system, iOS, Mac operating system, Windows operating system, Bada operating system and Symbian operating system.

Further, the one or more communication devices 104 include an internet facility. In an embodiment of the present disclosure, the one or more communication devices 104 are presently connected to the internet. In another embodiment of the present disclosure, the one or more communication devices 104 are not connected to the internet. In an embodiment of the present disclosure, the one or more communication devices 104 are connected to the internet through a data connection provided by a telecom service provider. In another embodiment of the present disclosure, the one or more communication devices 104 are connected to an internet broadband system, a local area network, a wide area network, a digital or analog cable television network or any other communication network presently known in the art. The internet broadband system maybe a wired or a wireless system.

In an embodiment of the present disclosure, the one or more communication devices 104 include one or more browsers 104a pre-installed in the one or more communication devices 104. The one or more browsers 104a enable the plurality of users 102 to access the internet. In an embodiment of the present disclosure, the plurality of users 102 accesses the one or more communication devices 104 for accessing a publisher of the one or more publishers 112 on a browser of the one or more browsers 104a. In an embodiment of the present disclosure, the plurality of users 102 accesses one or more websites of the corresponding one or more publishers 112 for accessing any content. In an embodiment of the present disclosure, the website accessed by the plurality of users 102 on the one or more communication devices 104 may show content related to interests of the plurality of users 102.

The one or more browsers 104a include but may not be limited to google chrome, internet explorer, Mozilla firefox, and opera mini. In addition, the content accessed by the plurality of users 102 on the corresponding one or more browsers 104a include one or more sports content, one or more news content, one or more movies content, one or more e-commerce content and the like. The one or more browsers 104a allow the plurality of users 102 to access the one or more websites based on his/her choice. The one or more websites are associated with the one or more publishers 112 hosting the one or more websites on the web.

In addition, the one or more websites display the one or more content for the plurality of users 102. Further, the one or more content may be an audio content, an audio-video content, a video content, a text content and the like. The one or more websites include an e-commerce website, a social networking website, a news website, a blog, photo sharing website or any other type of website providing the one or more content to the plurality of users 102.

In addition, the one or more publishers 112 correspond to one or more website owners for providing content to the user of the plurality of users 102. Further, the one or more publishers 112 provide the one or more users 102 with a single type of content or a multiple type of content. The type of content includes one or more video content, one or more audio content, one or more text content, one or more audio-video content and the like. Furthermore, each of the one or more publishers 112 is associated with a specific category of publishers. The one or more publishers 112 include but may not be limited to Dailytrust, Guardian, Punch, Naij and Linda Ikeji. In an embodiment of the present disclosure, the publisher of the one or more publishers 112 accessed by the user of the plurality of users 102 corresponds to an e-commerce publisher.

Moreover, the one or more publishers 112 provide space, areas or a part of their web pages for advertising purposes. These areas or spaces on the web pages are referred to as advertisement slots. The web page can have the various advertisement slots depending on choice of each of the one or more publishers 112. The one or more publishers 112 advertise products, services or businesses to the one or more users for generating revenue.

In an embodiment of the present disclosure, the one or more publishers 112 display the one or more advertisements on the corresponding advertisement slots in the web pages of the one or more publishers 112. In an embodiment of the present disclosure, the one or more publishers 112 display the one or more advertisements when the user requests for the content to be displayed on the one or more publishers 112 website. In an embodiment of the present disclosure, the one or more advertisements are displayed for generating revenue based on number of impressions, number of clicks and number of installs taken by the user. In an embodiment of the present disclosure, the one or more advertisements are displayed during viewing of the content. In an example, a user X encounters an advertisement while viewing one or more products on a publisher Y. In another embodiment of the present disclosure, the one or more advertisements are displayed along with the content viewed by the user of the plurality of users 102 on the one or more publishers 112.

In addition, the plurality of users 102 sends a plurality of hypertext transfer protocol requests associated with one or more publishers 112 through one or more browsers 104a. In an embodiment of the present disclosure, the plurality of hypertext transfer protocols enable the one or more publishers 112 to collect information associated with the user of the plurality of users 102. The information includes a browsing history, behavioral information, interests of the user and the like. The information is collected by the one or more publishers 112 in real-time.

In addition, the one or more advertisers 114 purchase the one or more advertisement slots and user unique identity from the one or more publishers 112. In an embodiment of the present disclosure, the one or more advertisers 114 purchase the advertisement slots for displaying the one or more advertisements on the corresponding advertisement. In an embodiment of the present disclosure, the one or more advertisers 114 generate revenue based on the number of impressions, the number of clicks and the number of installs. Further, the one or more advertisers 114 provide the one or more advertisements to the one or more publishers 112 in real time.

In an embodiment of the present disclosure, the one or more advertisements displayed are associated with the interests of the user of the plurality of users 102. In an embodiment of the present disclosure, the one or more advertisements correspond to a content viewing history of the one or more users for attracting more number of clicks from the one or more users in order to increase the revenue generation. In addition, the one or more advertisers 114 and the one or more publishers 112 are associated through one or more advertisement supplying intermediaries.

Further, the advertisement supplying intermediaries enables a connection or link between the one or more publishers 112 and the one or more advertisers 114. In an embodiment of the present disclosure, the advertisement supplying intermediaries works as a third party medium for efficient buying and selling of the one or more advertisement slots. In an embodiment of the present disclosure, the advertisement supplying intermediaries is a platform for buying and selling of advertisement inventory between the one or more publishers 112 and the one or more advertisers 114. In an embodiment of the present disclosure, the advertisement supplying intermediaries deal with the one or more publishers 112 and the one or more advertisers 114 through a mutual contract for defining terms and conditions associated with revenue.

In addition, the one or more communication devices 104 are associated with the communication network 106. In an embodiment of the present disclosure, the one or more communication devices 104 are associated with the one or more publishers 112 and the one or more advertisers 114 through the communication network 106. In an embodiment of the present disclosure, the advertisement supplying intermediaries is associated with the one or more publishers 112 and the one or more advertisers 114 through the communication network 106.

In addition, the communication network 106 enables the one or more communication devices 104 to connect to the internet. In an embodiment of the present disclosure, the user accesses the one or more publishers 112 on the corresponding communication device through the communication network 106. Further, the medium for communication may be infrared, microwave, radio frequency (RF) and the like. The communication network 106 includes but may not be limited to a local area network, a metropolitan area network, a wide area network, a virtual private network, a global area network and a home area network. The communication network 106 is a structure of various nodes or communication devices connected to each other through a network topology method. The network topology includes a bus topology, a star topology, a mesh topology and the like.

In addition, the one or more publishers 112 and the one or more advertisers 114 are associated with the user identifier system 108. In an embodiment of the present disclosure, the one or more publishers 112 and the one or more advertisers 114 are associated with the user identifier system 108 through the communication network 106. Moreover, the user identifier system 108 performs the fetching, storing and identifying each of the plurality of users 102 connected on the web pages of the one or more publishers 112 for serving the one or more advertisements in real time. In an embodiment of the present disclosure, the user identifier system 108 manages the plurality of hypertext transfer protocol requests and the plurality of hypertext transfer protocols of the one or more users 102 in real time.

In addition, the user identifier system 108 includes a user network information fetcher 108a and a cookie storing module 108b. Further, the user identifiers system 108 enables modification of the plurality of hypertext transfer protocol headers with hypertext transfer protocol enrichment. The plurality of hypertext transfer protocol headers is associated with the one or more publishers 112. The hypertext transfer protocol enrichment allows the one or more communication devices 104 operator to annotate hypertext transfer protocol connections via the use of a wide range of header requests. The plurality of hypertext transfer protocol headers is modified in real-time.

In addition, the user network information fetcher 108a extracts a user data associated with the user of the plurality of users 102 based on modified hypertext transfer protocol header. Further, the user data is associated with one or more user network information. Furthermore, the user network information fetcher 108a extracts the user data in real-time. Moreover, the user data includes the one or more user network information. Also, the one or more user network information includes but may not be limited to mobile station international subscriber directory number, international mobile subscriber identity and international mobile equipment identity.

In addition, the cookie storing module 108b maps the user data to the unique cookie identity based on the cookie syncing. In general, cookie is small text file collecting information about users. Each time user visits website, cookies are created by browser and saved onto user's communication device. When that user returns to website, the cookies help it to remember content the user viewed and pages accessed. The cookie syncing enables mapping of the user of the plurality of users 102 through sending the unique cookie identity to the cookie storing module 108b. Further, the cookie storing module 108b stores the unique cookie identity of each of the plurality of users 102. Furthermore, the cookie storing module 108b stores and maps the unique cookie identity of the user of the plurality of users 102 in real-time

In addition, the user identifier system 108 transfers the unique cookie identity of the user of the plurality of users 102 to the corresponding one or more communication devices 104. Further, the user identifier system 108 transfers the unique cookie identity of the user of the plurality of users 102 in real-time. Furthermore, the user identifier system 108 retrieves the unique cookie identity of the user of the plurality of users 102 after the user accesses the corresponding one or more publishers 112. The user identifier system 108 retrieves the unique cookie identity of the user of the plurality of users 102 in real-time.

Moreover, the user identifier system 108 enables accessibility of the one or more publisher 112 to each of the plurality of users 102 through the one or more communication devices 104 across the internet and non-internet channels. Also, the user identifier system 108 enables accessibility of the one or more publisher 112 to each of the plurality of users 102 due to the stored and mapped unique cookie identity. The one or more publisher 112 and the one or more advertisers 114 identify each of the plurality of users 102 due to the stored and mapped unique cookie identity across the internet and non-internet channels. The one or more publisher 112 and the one or more advertisers 114 identify each of the plurality of users 102 in real-time. Also, the user identifier system 108 enables identification and sending of the one or more advertisements to the each of the plurality of users 102 through the one or more advertisers 114. The one or more advertisers 114 are able to send the one or more advertisement to the identified user based on the user data in stored in the cookie storing module 108b and the user network information fetcher 108a.

In addition, the one or more publishers 112, the one or more advertisers 114 and the user identifier system 108 are associated with the server 110. In an embodiment of the present disclosure, the one or more publishers 112, the one or more advertisers 114 and the user identifier system 108 are associated with the server 110 through the communication network 106. Further, the server 110 is configured to provide the one or more advertisements to the one or more publishers 112 in real-time based on a request by the one or more publishers 112. In an embodiment of the present disclosure, the server 110 is linked a server associated with the one or more publishers 112 and a server associated with the one or more advertisers 114. In an embodiment of the present disclosure, the server 110 is a part of the user identifier system 108 for providing identification of each of the plurality of users 102 in real time based on the request by the user identifier system 108. In an embodiment of the present disclosure, the server 110 is a third party ad server. In an embodiment of the present disclosure, the server 110 stores the one or more advertisements for the one or more advertisers 114. In an embodiment of the present disclosure, the server 110 stores the unique cookie identity of each of the plurality of users 102 for the one or more publishers 112.

FIGS. 2A and 2B illustrate a flow chart 200 of the method for uniquely identifying a mobile user across internet and non-internet channels, in accordance with various embodiments of the present disclosure. It may be noted that in order to explain the method steps of the flowchart 200, references will be made to the elements explained in FIG. 1. The flow chart 200 starts at step 202. At step 204, the user identifier system 108 receives the plurality of hypertext transfer protocol requests associated with the one or more publishers 112 through the one or more browsers 104a. At step 206, the user identifier system 108 enables modification of the plurality of hypertext transfer protocol headers with the hypertext transfer protocol enrichment associated with the one or more publishers 112. At step 208, the user identifier system 108 extracts the user data associated with the plurality of users 102 based on the modified hypertext transfer protocol header through the user network information fetcher 108a. At step 210, the user identifier system 108 maps the user data associated with each of the plurality of users 102 to the unique cookie identity in the cookie storing module 108b based on the cookie syncing. At step 212, the user identifier system 108 transfers the unique cookie identity associated with the corresponding plurality of users 102 to the corresponding one or more communication devices 104. At step 214, the user identifier system 108 retrieves the unique cookie identity associated with the one or more communication devices 104 when the plurality of users 102 access same one or more publishers. At step 216, the user identifier system 108 engages the plurality of users 102 associated with the one or more communication devices 104 to the one or more publishers 112 across internet and non-internet channels.

The flow chart 200 terminates at step 218. It may be noted that the flowchart 200 is explained to have above stated process steps; however, those skilled in the art would appreciate that the flowchart 200 may have more/less number of process steps which may enable all the above stated embodiments of the present disclosure.

FIG. 3 illustrates the block diagram of a computing device 300, in accordance with various embodiments of the present disclosure. The computing device 300 includes a bus 302 that directly or indirectly couples the following devices: memory 304, one or more processors 206, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The present disclosure has several advantages over the prior art. The present disclosure provides high efficiency to identify a user identity across internet and non-internet channels in real-time. The present disclosure provides engagement and identification of the user on the non-internet channel once the user is identified on the internet channel in real-time. The present disclosure provides engagement and identification of the user on the internet channel once the user is identified on the non-internet channel in real-time.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method for uniquely identifying a mobile user across internet and non-internet channels, the computer-implemented method comprising:
receiving, at a user identifier system with a processor, a plurality of hypertext transfer protocol requests associated with one or more publishers through one or more browsers, wherein the one or more browsers are associated with one or more communication devices, wherein the one or more communication devices are associated with a plurality of users, wherein the plurality of hypertext transfer protocol requests is received in real-time;
enabling, at the user identifier system with the processor, modification of a plurality of hypertext transfer protocol headers with hypertext transfer protocol enrichment associated with the one or more publishers, wherein the plurality of hypertext transfer protocol headers is modified in real-time;
extracting, at the user identifier system with the processor, a user data associated with the plurality of users based on the modified hypertext transfer protocol header through a user network information fetcher, wherein the user data is associated with one or more user network information, wherein the user data is extracted in real-time;
mapping, at the user identifier system with the processor, the user data associated with each of the plurality of users to a unique cookie identity in a cookie storing module based on cookie syncing, wherein the cookie storing module is associated with the user identifier system, wherein the unique user identity is mapped in real-time;
transferring, at the user identifier system with the processor, the unique cookie identity associated with the corresponding plurality of users to the corresponding one or more communication devices, wherein the unique cookie identity is transferred in real-time;
retrieving, at the user identifier system with the processor, the unique cookie identity associated with the corresponding one or more communication devices when the plurality of users accesses the same one or more publishers, wherein the unique cookie identity is retrieved in real-time; and
engaging, at the user identifier system with the processor, the plurality of users associated with the one or more communication devices to the one or more publishers across internet and non-internet channels, wherein the user is engaged in real-time,
wherein each of the plurality of users engaging across the internet and non-internet channels is identified due to the mapped unique cookie identity of the user of the plurality of users.

2. The computer-implemented method as recited in claim 1, wherein the plurality of hypertext transfer protocol requests is initiated through the one or more browsers from the plurality of users, wherein the plurality of users receives the response from the one or more publishers after processing the plurality of hypertext transfer protocol requests to access the one or more publishers webpage.

3. The computer-implemented method as recited in claim 1, wherein the one or more browsers is an application for accessing the information on the one or more publishers, wherein the one or more browsers is pre-installed in the one or more communication devices, wherein the one or more browsers enable the plurality of users to access the internet through a communication network.

4. The computer-implemented method as recited in claim 1, wherein the one or more publishers comprises one or more website owners for providing content to a user of the plurality of users, wherein the content comprises one or more video contents, one or more audio contents, one or more text contents and one or more audio-video content.

5. The computer-implemented method as recited in claim 1, wherein the one or more communication devices comprise a personal e-mail device, a personal data assistant, a cellular telephone, a smartphone, a laptop computer, and the tablet computer, wherein the plurality of users accesses the one or more publishers through the one or more communication devices using the communication network.

6. The computer-implemented method as recited in claim 1, wherein the plurality of hypertext transfer protocol headers of the plurality of hypertext transfer protocol requests for the one or more publishers is modified with the hypertext transfer protocol enrichment, wherein the plurality of hypertext transfer protocol headers is modified to enable extraction of the unique user identity.

7. The computer-implemented method as recited in claim 1, wherein the user data comprises the one or more user network information, wherein the one or more user network information comprise mobile station international subscriber directory number, international mobile subscriber identity and international mobile equipment identity, wherein the user data is mapped to the unique cookie identity in a cookie storing module based on the cookie syncing.

8. The computer-implemented method as recited in claim 1, wherein the cookie syncing maps the user of the plurality of users through sending the unique cookie identity to the cookie storing module, wherein the cookie storing module stores the unique cookie identity of each of the plurality of users.

9. The computer-implemented method as recited in claim 1, wherein the unique cookie identity of the user of the plurality of users is transferred to the corresponding one or more communication devices, wherein the transferred unique cookie identity of the user of the plurality of users is retrieved after the user accesses the corresponding one or more publishers.

10. The computer-implemented method as recited in claim 1, wherein each of the plurality of users accesses the one or more publisher through the one or more communication devices across internet and non-internet channels due to the stored and mapped unique cookie identity, wherein the one or more publisher and one or more advertisers identify each of the plurality of users due to the stored and mapped unique cookie identity.

11. A computer system comprising:
one or more processors; and
a memory coupled to the one or more processors, the memory for storing instructions which, when executed by the one or more processors, cause the one or more processors to perform a method for uniquely identifying a mobile user across internet and non-internet channels, the method comprising:
receiving, at a user identifier system, a plurality of hypertext transfer protocol requests associated with one or more publishers through one or more browsers, wherein the one or more browsers are associated with one or more communication devices, wherein the one or more communication devices are associated with a plurality of users, wherein the plurality of hypertext transfer protocol requests is received in real-time;
enabling, at the user identifier system, modification of a plurality of hypertext transfer protocol headers with hypertext transfer protocol enrichment associated with the one or more publishers, wherein the plurality of hypertext transfer protocol headers is modified in real-time;
extracting, at the user identifier system, a user data associated with the plurality of users based on the modified hypertext transfer protocol header through a user network information fetcher, wherein the user data is associated with one or more user network information, wherein the user data is extracted in real-time;
mapping, at the user identifier system, the user data associated with each of the plurality of users to a unique cookie identity in a cookie storing module based on cookie syncing, wherein the cookie storing module is associated with the user identifier system, wherein the unique user identity is mapped in real-time;
transferring, at the user identifier system, the unique cookie identity associated with the corresponding plurality of users to the corresponding one or more communication devices, wherein the unique cookie identity is transferred in real-time;
retrieving, at the user identifier system, the unique cookie identity associated with the corresponding one or more communication devices when the plurality of users accesses the same one or more publishers, wherein the unique cookie identity is retrieved in real-time; and
engaging, at the user identifier system, the plurality of users associated with the one or more communication devices to the one or more publishers across internet and non-internet channels, wherein the user is engaged in real-time,
wherein the user identifier system identifies each of the plurality of users engaging across the internet and non-internet channels due to the mapped unique cookie identity of the user of the plurality of users.

12. The computer system as recited in claim 11, wherein the plurality of hypertext transfer protocol requests is initiated through the one or more browsers from the plurality of users, wherein the plurality of users receives the response from the one or more publishers after processing the plurality of hypertext transfer protocol requests to access the one or more publishers webpage.

13. The computer system as recited in claim 11, wherein the one or more publishers comprises one or more website owners for providing content to a user of the plurality of users, wherein the content comprises one or more video contents, one or more audio contents, one or more text contents and one or more audio-video content.

14. The computer system as recited in claim 11, wherein the one or more communication devices comprise a personal e-mail device, a personal data assistant, a cellular telephone, a smartphone, a laptop computer, and the tablet computer, wherein the plurality of users accesses the one or more publishers through the one or more communication devices using the communication network.

15. The computer system as recited in claim 11, wherein the plurality of hypertext transfer protocol headers of the plurality of hypertext transfer protocol requests for the one or more publishers is modified with the hypertext transfer protocol enrichment, wherein the plurality of hypertext transfer protocol headers is modified to enable extraction of the unique user identity.

16. The computer system as recited in claim 11, wherein the user data comprises the one or more user network information, wherein the one or more user network information comprise mobile station international subscriber directory number, international mobile subscriber identity and international mobile equipment identity, wherein the user data is mapped to the unique cookie identity in a cookie storing module based on the cookie syncing.

17. The computer system as recited in claim 11, wherein the cookie syncing maps the user of the plurality of users through sending the unique cookie identity to the cookie storing module, wherein the cookie storing module stores the unique cookie identity of each of the plurality of users.

18. The computer system as recited in claim 11, wherein the unique cookie identity of the user of the plurality of users is transferred to the corresponding one or more communication devices, wherein the transferred unique cookie identity of the user of the plurality of users is retrieved after the user accesses the corresponding one or more publishers.

19. The computer system as recited in claim 11, wherein each of the plurality of users accesses the one or more publisher through the one or more communication devices across internet and non-internet channels due to the stored and mapped unique cookie identity, wherein the one or more publisher and one or more advertisers identify each of the plurality of users due to the stored and mapped unique cookie identity.

20. A non-transitory computer-readable storage medium encoding computer executable instructions that, when executed by at least one processor, performs a method for uniquely identifying a mobile user across internet and non-internet channels, the method comprising:
receiving, at a computing device, a plurality of hypertext transfer protocol requests associated with one or more publishers through one or more browsers, wherein the one or more browsers are associated with one or more communication devices, wherein the one or more communication devices are associated with a plurality of users, wherein the plurality of hypertext transfer protocol requests is received in real-time;
enabling, at the computing device, modification of a plurality of hypertext transfer protocol headers with hypertext transfer protocol enrichment associated with the one or more publishers, wherein the plurality of hypertext transfer protocol headers is modified in real-time;
extracting, at the computing device, a user data associated with the plurality of users based on the modified hypertext transfer protocol header through a user network information fetcher, wherein the user data is associated with one or more user network information, wherein the user data is extracted in real-time;
mapping, at the computing device, the user data associated with each of the plurality of users to a unique cookie identity in a cookie storing module based on cookie syncing, wherein the cookie storing module is associated with the user identifier system, wherein the unique user identity is mapped in real-time;
transferring, at the computing device, the unique cookie identity associated with the corresponding plurality of users to the corresponding one or more communication devices, wherein the unique cookie identity is transferred in real-time;
retrieving, at the computing device, the unique cookie identity associated with the corresponding one or more communication devices when the plurality of users (102) accesses the same one or more publishers (112), wherein the unique cookie identity is retrieved in real-time; and
engaging, at the computing device, the plurality of users (102) associated with the one or more communication devices (104) to the one or more publishers (112) across internet and non-internet channels, wherein the user is engaged in real-time, wherein each of the plurality of users (102) engaging across the internet and non-internet channels is identified due to the mapped unique cookie identity of the user of the plurality of users (102).
